(19) United States
(12) Patent Application Publication
(10) Pub. No.: US 2007/0225186 A1
(43) Pub. Date: Sep. 27, 2007

(54) Alkaline solutions for post CMP cleaning processes

(76) Inventor: Matthew Fisher, Allen, TX (US)

Correspondence Address: Linda K. Russell;Patent Counsel, Air Liquide, 2700 Post Oak Blvd., Suite 1800, Houston, TX, 77056, US

(21) Appl. No.: 11/478,317

(22) Filed: Jun. 30, 2006

Related U.S. Application Data
(60) Provisional application No. 60/786,177, filed on Mar. 27, 2006.
(60) Provisional application No. 60/791,538, filed on Apr. 12, 2006.

(51) Int. Cl. C11D 7/32

(52) U.S. Cl. 510/175

(57) ABSTRACT

Alkaline post CMP cleaning solutions are provided including at least two basic compounds that can be organic amines and/or quaternary ammonium hydroxides, at least one organic acid compound, and an inhibitor compound that inhibits corrosion of materials. The inhibitor compound is preferably a mercaptan compound. In one embodiment, a cleaning solution includes at least two organic amines but is substantially free of quaternary ammonium hydroxides. The cleaning solutions preferably have a pH ranging from about 7 to about 12.

### CROSS-REFERENCE TO RELATED APPLICATIONS

This application claims priority from U.S. Provisional Patent Application Ser. No. 60/786,177, entitled “Alkaline Post CMP Cleaning Chemistry for Improved Copper Corrosion Resistance,” and filed Mar. 27, 2006, and from U.S. Provisional Patent Application Ser. No. 60/791,538, entitled “Alkaline Post CMP Cleaning Chemistry Free of Quarternary Ammonium Compounds,” and filed Apr. 12, 2006. The disclosures of these provisional patent applications are incorporated herein by reference in their entireties.

### BACKGROUND

1. Field

The disclosure pertains to alkaline chemistries for cleaning copper and low k surfaces after chemical mechanical polishing and planarization.

2. Related Art

Chemical mechanical polishing or planarization (CMP) is a technique utilized in semiconductor fabrication processes in which the top surface of a semiconductor component or substrate is planarized. The semiconductor component is typically a silicon based wafer with active regions formed in or on the wafer and with interconnects formed of a metal (typically copper or tungsten) that is deposited in etched lines along the wafer so as to connect the active regions. The CMP process is used to remove excess copper that has been deposited on the semiconductor component so as to planarize the surface. CMP processes typically involve rotating the semiconductor substrate against a wetted polishing surface under controlled conditions. The chemical polishing agent includes a slurry of an abrasive material (e.g., alumina or silica) and other chemical compounds that interact with the substrate surface during the CMP process.

While CMP is effective in planarizing a substrate surface, this process leaves contaminants at the surface, requiring the application of post CMP cleaning solutions to remove such contaminating residues. For example, copper residues on low k films can degrade the dielectric properties of such films, while other particles from the CMP process can increase the contact resistance, limit the conductivity of the interconnect material and lead to poor adhesion of overlying layers. Therefore, such particles or residues must be removed from the substrate surface in a post CMP cleaning process.

A number of chemistries are known for post CMP cleaning of semiconductor components. In particular, certain cleaning chemistries or solutions are alkaline, including strong basic compounds such as quaternary ammonium hydroxides that inhibit or prevent re-adhesion of particles that are removed from the component surface during cleaning. Other cleaning solutions are acidic and include one or more suitable acids to ensure sufficient dissolution and removal of metal impurities from the component surface.

While some of the known post CMP cleaning solutions are effective at removing residual oxide and/or other particles as well as copper residues from the semiconductor component surface, such cleaning solutions can be corrosive toward metals such as copper. In addition, some of these cleaning solutions are incapable of providing a surface film to protect against metal corrosion during the cleaning process, particularly when a corrosive compound such as tetramethylammonium hydroxide (TMAH) is used, while other cleaning solutions do not include any corrosion inhibiting compounds at all.

It is desirable to provide a post CMP cleaning solution that effectively treats a semiconductor component surface to remove metal and other impurities while effectively inhibiting corrosion of the exposed interconnects on the substrate surface.

### SUMMARY

Alkaline post CMP solutions are described herein which effectively clean semiconductor components to remove metals such as copper and/or other residues from a metal or low k surface after a CMP process while effectively minimizing or preventing corrosion of the metal interconnects of the components.

An exemplary cleaning solution comprises at least two organic base compounds selected from the group consisting of organic amines and quaternary ammonium hydroxides, at least one carboxylic acid, and a mercaptan compound. The mercaptan compound can be a mercapto carboxylic acid, such as mercaptopropionic acid or cysteine. The cleaning solution preferably has a pH in a range from about 7 to about 12.

In another embodiment, a cleaning solution comprises at least two organic amine compounds, at least one organic carboxylic acid, and an inhibitor compound that inhibits corrosion of metals. The cleaning solution is further substantially free of ammonium hydroxide compounds. The inhibitor compound can be a mercaptan compound. Preferably, the cleaning solution has a pH in the range from about 7 to about 11, more preferably in the range from about 9 to about 10.5.

The cleaning solutions described herein can be contacted with a surface of a semiconductor component to effectively clean the component surface while inhibiting corrosion of metal portions of the surface.

The above and still further features and advantages will become apparent upon consideration of the following detailed description of specific embodiments thereof.

### DETAILED DESCRIPTION

Alkaline chemistries or solutions that are effective for cleaning substrate surfaces that include metal debris and other contaminants include at least two basic compounds, at least one organic acid compound, and an inhibitor compound that inhibits corrosion of metals.

The alkaline solutions are particularly effective in post chemical mechanical polishing or planarization (CMP) processes of semiconductor component surfaces, where the removal of metals such as copper, oxides, organic residues and/or other contaminating residues from the component surface is required.

The combination of basic and acidic compounds in the alkaline solutions facilitate the effective removal of such contaminating residues by dissolving and/or complexing metals to facilitate removal of such metals as well as removing organic and/or other residues, while the inhibitor compound of the alkaline solutions minimizes or prevents corrosion of copper and/or other metals at the substrate surface.

Basic compounds provided in the cleaning solutions are preferably organic amine compounds, quaternary ammonium hydroxide compounds, or mixtures thereof. Exemplary organic amine compounds that are suitable for use in the cleaning solutions include, without limitation, primary, secondary or tertiary aliphatic amines such as methylamine, dimethylamine, trimethylamine, ethylamine, diethylamine, triethylamine, and alkanolamines (e.g., monoethanolamine, diethanolamine, aminoethanolamine, triethanolamine, isopropanolamine, diisopropanolamine, triisopropanolamine, (aminoethylamino)ethanol, etc.), aromatic amines, heterocyclic amines, and mixtures thereof.

Exemplary quaternary ammonium hydroxide compounds that are suitable for use in the cleaning solutions include, without limitation, ammonium hydroxide and tetraalkylammonium hydroxides such as tetramethylammonium hydroxide (TMAH), tetraethylammonium hydroxide, tetrapropylammonium hydroxide, trimethylethylammonium hydroxide, (2-hydroxyethyl)trimethylammonium hydroxide, (2-hydroxyethyl)triethylammonium hydroxide, (2-hydroxyethyl)tripropylammonium hydroxide, (1-hydroxypropyl)trimethylammonium hydroxide, and mixtures thereof.

In one exemplary embodiment, an alkaline cleaning solution includes a mixture of TMAH with isopropanolamine along with a suitable organic acid and a suitable inhibitor compound. However, it is noted that quaternary ammonium hydroxides such as TMAH can be highly corrosive to certain surfaces which are to be cleaned, such that it may be desirable in certain cleaning methods to avoid the use of such compounds in the cleaning solution. In addition, there are a number of safety and environmental hazards associated with the use of TMAH, which can increase the expense associated with handling and disposal of cleaning solutions utilizing TMAH.

Therefore, other embodiments of cleaning solutions that are effective in cleaning residues from substrate surfaces are substantially free of any quaternary ammonium hydroxide compounds. This group of cleaning solutions preferably includes at least two organic amines. In an exemplary embodiment, a cleaning solution includes a combination of isopropanolamine and (aminoethylamino)ethanol along with a suitable organic acid and a suitable inhibitor compound.

Organic acid compounds that are suitable for use in the cleaning solutions are strong complexing agents for copper and include, without limitation, acetic acid, propionic acid, butyric acid, benzoic acid, gluconic acid, glutamic acid, lactic acid, aspartic acid, tartaric acid, ascorbic acid, gallic acid, caffeic acid, cinnamic acid, tannic acid, vanillic acid, oxalic acid, citric acid, salicylic acid, malonic acid, malic acid, fumaric acid maleic acid, and mixtures thereof.

As noted above, the cleaning solutions contain at least one inhibitor compound that inhibits or prevents the corrosion or oxidation of copper and/or other metals. Suitable corrosion inhibitor compounds may be of the following types: reducing compounds, film-forming compounds, antioxidants and/or oxygen scavenger compounds. Some of the organic acids noted above are suitable as corrosion inhibitors to protect the substrate surface. In particular, suitable inhibitor compounds are compounds that inhibit or prevent the oxidation of copper. Examples of suitable inhibitor compounds that fall within one or more of these inhibitor types include, without limitation, acetamidophenol, aminophenol, ascorbic acid, caffeic acid, cinnamic acid, dihydroxybenzoic acid, glucose, imidazole, mercaptan compounds such as mercaptothiazoline, mercaptoethanol, mercaptopropionic acid, cysteine, mercaptobenzothiazole, mercaptomethylimidazole, methoxyphenol, tannic acid, thioglycerol, salicylic acids, thiosalicylic acid, triazole, vanillin, vanillic acid, and mixtures thereof.

In certain cleaning applications, such as applications in which the cleaning chemistry is highly corrosive to copper, it is preferable to utilize a film-forming compound as the inhibitor compound in the cleaning solution. However, certain film-forming inhibitor compounds (e.g., triazole compounds such as benzotriazole) form thick film layers on the substrate surface being cleaned, which can have the effect of preventing removal of certain residues from the substrate surface and less effective cleaning. The use of one or more mercaptan compounds (e.g., mercaptan compounds that do not include benzotriazole) provides a thin film layer that effectively inhibits or prevents corrosion of metals such as copper on the substrate surface while facilitating effective cleaning of residues from the surface. In particular, mercapto carboxylic acids, such as mercaptopropionic acid and cysteine, are very effective in inhibiting corrosion of the substrate surface.

The cleaning solutions can further include any conventional and/or other types of suitable additives (e.g., surfactants, sticking agents such as polyethylene glycol or polypropylene glycol, etc.) that enhance the performance and effect of the cleaning solutions. For example, any one or more suitable types of surfactants, such as non-ionic, anionic, cationic, zwitterionic and/or amphoteric surfactants, can be provided in the cleaning solutions to enhance wetting of hydrophobic surfaces of the substrate during cleaning applications.

The cleaning solutions can include from about 3% to about 12% by weight of the basic compounds, from about 0.25% to about 5% by weight of one or more organic acid compounds, and about 0.1% to about 5% by weight of one or more inhibitor compounds in a suitable solvent such as deionized water.

It is noted that these weight percentage ranges refer to undiluted cleaning solutions, and such cleaning solutions are preferably diluted to suitable concentrations prior to being used in a cleaning application. For example, the cleaning solutions having chemistries within the weight percentage ranges as noted above can be diluted from about 50 times to about 100 times with deionized water while ensuring an effective cleaning of a substrate surface at such diluted levels.

Preferably, a diluted cleaning solution includes from about 0.05% to about 0.2% by weight of the basic compounds, from about 0.002% to about 0.1% by weight of one or more organic acid compounds, and about 0.004% to about 0.1% by weight of one or more inhibitor compounds in deionized water.

In one exemplary embodiment, a cleaning solution includes about 3% by weight of TMAH, about 6% by weight of isopropanolamine, about 2% by weight of salicylic acid, and about 1% by weight of mercaptopropionic acid in deionized water. This solution can be diluted about 60 times to a final concentration of about 0.05% by weight of TMAH, about 0.10% isopropanolamine, about 0.033% by weight of salicylic acid, and about 0.0167% by weight of mercaptopropionic acid in deionized water.

In another exemplary embodiment, a cleaning solution includes about 6% by weight of isopropanolamine, about 5% by weight of (aminoethylamino)ethanol, about 4% by weight of ascorbic acid, and about 1.5% by weight of salicylic acid in deionized water. This solution can be diluted about 60 times to a final concentration of about 0.1% by weight of isopropanolamine, about 0.0833% by weight of (aminoethylamino)ethanol, about 0.067% by weight of ascorbic acid, and about 0.025% by weight of salicylic acid in deionized water.

The cleaning solutions described above can be prepared by mixing or combining the basic compounds, one or more organic acid compounds and one or more inhibitor compounds in deionized water in any suitable manner so as to form a generally homogenous mixture of the compounds in the cleaning solution. The cleaning solution chemistry is further prepared such that the pH of the cleaning solution is preferably within a range from about 7 to about 12. For example, for cleaning solutions that do not include TMAH, a suitable cleaning chemistry can be prepared such that the pH of the cleaning solution is in the range from about 7 to about 11, preferably from about 9 to about 10.5. When TMAH is provided as one of the basic compounds in the cleaning solution, the solution chemistry can be prepared such that the pH of the cleaning solution is in the range from about 11 to about 12.

Upon obtaining the desired concentration for a cleaning solution (e.g., by appropriate dilution with deionized water from initial concentrations to desired cleaning concentrations), a cleaning solution is applied in any conventional or other suitable manner to the surface of a substrate. In an exemplary embodiment, a semiconductor wafer is provided with active regions formed in the wafer and with copper interconnects that are deposited in etched lines along the wafer and connect with the active regions. The wafer surface has been planarized using a CMP process. A cleaning solution having a suitable chemistry as described above is then applied to contact the wafer surface in a post-CMP cleaning process. The contacting of the cleaning solution with the wafer surface can be performed, for example, by brushing or scrubbing the wafer surface with the cleaning solution, by spraying the cleaning solution onto the wafer surface, by immersing or soaking portions of the wafer in a tank of the cleaning solution, and combinations thereof.

The cleaning solutions described above are very effective in removing metal, organic and/or other residues from a substrate surface during post CMP cleaning processes while protecting the substrate from surface corrosion. In addition, the cleaning solutions described above that avoid the use of TMAH provide safer and more environmentally acceptable chemistries.

Having described novel alkaline solutions for post CMP cleaning processes and corresponding methods for cleaning semiconductor component surfaces with such solutions, it is believed that other modifications, variations and changes will be suggested to those skilled in the art in view of the teachings set forth herein. It is therefore to be understood that all such variations, modifications and changes are believed to fall within the scope as defined by the appended claims.

1. A cleaning solution comprising:
at least two basic compounds selected from the group consisting of organic amines and quaternary ammonium hydroxides;
at least one organic acid compound; and
a mercaptan compound.

2. The solution of claim 1, wherein the pH of the solution is in the range from about 7 to about 12.

3. The solution of claim 1, wherein the at least two basic compounds include an organic amine and tetramethyl ammonium hydroxide.

4. The solution of claim 1, wherein the mercaptan compound comprises a mercapto carboxylic acid.

5. The solution of claim 4, wherein the mercaptan compound comprises at least one of mercaptopropionic acid and cysteine.

6. The solution of claim 1, wherein the solution has a suitable composition such that, upon about 50 times to about 100 times dilution with deionized water, the diluted solution has a composition that includes about 0.05% to about 0.2% by weight of the at least two basic compounds in the diluted solution, about 0.002% to about 0.1% by weight of the at least one organic acid in the diluted solution, and about 0.004% to about 0.1% by weight of the mercaptan compound in the diluted solution.

7. The solution of claim 1, wherein the solution includes tetramethyl ammonium hydroxide, isopropanolamine, salicylic acid and mercaptopropionic acid.

8. The solution of claim 1, wherein the solution is substantially free of quaternary ammonium hydroxide compounds.

9. The solution of claim 1, wherein the at least one organic acid compound is a complexing agent for copper.

10. A cleaning solution comprising:
at least two organic amine compounds;
at least one organic acid compound; and
an inhibitor compound that inhibits corrosion of metals;
wherein the solution is substantially free of quaternary ammonium hydroxide compounds.

11. The solution of claim 10, wherein the inhibitor compound comprises an antioxidant that inhibits or prevents the oxidation of copper.

12. The solution of claim 10, wherein the inhibitor compound comprises a mercaptan compound.

13. The solution of claim 10, wherein the solution includes isopropanolamine, (aminoethylamino)ethanol, ascorbic acid and salicylic acid.

14. The solution of claim 10, wherein the pH of the solution is in the range from about 7 to about 11.

15. The solution of claim 10, wherein the pH of the solution is in the range from about 9 to about 10.5.

16. The solution of claim 10, wherein the at least one organic acid compound is a complexing agent for copper.

17. A method of cleaning a semiconductor component, the method comprising:
providing a cleaning solution comprising at least two basic compounds selected from the group consisting of organic amines and quaternary ammonium hydroxides, at least one organic acid compound, and a mercaptan compound; and
contacting a surface of the semiconductor component with the cleaning solution.

18. The method of claim 17, wherein the pH of the cleaning solution is in the range from about 7 to about 12.

19. The method of claim 17, wherein the at least two organic base compounds include an organic amine and tetramethyl ammonium hydroxide.

20. The method of claim 17, wherein the mercaptan compound comprises a mercapto carboxylic acid.

21. The method of claim 20, wherein the mercaptan compound comprises at least one of mercaptopropionic acid and cysteine.

22. The method of claim 17, further comprising:
prior to contacting the surface of the semiconductor component with the cleaning solution, diluting the cleaning solution from about 50 times to about 100 time with deionized water such that the diluted cleaning solution includes about 0.05% to about 0.2% by weight of the at least two basic compounds in the diluted solution, about 0.002% to about 0.1% by weight of the at least one organic acid in the diluted solution, and about 0.004% to about 0.1% by weight of the mercaptan compound in the diluted solution.

23. The method of claim 17, wherein the solution includes tetramethyl ammonium hydroxide, isopropanolamine, salicylic acid and mercaptopropionic acid.

24. The method of claim 17, wherein the solution is substantially free of ammonium hydroxide compounds.

25. The method of claim 17, wherein the at least one organic acid compound is a complexing agent for copper.

26. A method of cleaning a semiconductor component, the method comprising:
providing a cleaning solution comprising at least two organic amine compounds, at least one organic acid compound, and an inhibitor compound that inhibits corrosion of metals, wherein the cleaning solution is substantially free of ammonium hydroxide compounds; and
contacting a surface of the semiconductor component with the cleaning solution.

27. The method of claim 26, wherein the inhibitor compound comprises a mercaptan compound.

28. The method of claim 26, wherein the inhibitor compound comprises an antioxidant that inhibits or prevents the oxidation of copper.

29. The method of claim 26, wherein the cleaning solution includes isopropanolamine, (aminoethylamino)ethanol, ascorbic acid and salicylic acid.

30. The method of claim 26, wherein the pH of the cleaning solution is in the range from about 7 to about 11.

31. The method of claim 26, wherein the at least one organic acid compound is a complexing agent for copper.
